(19) United States
(12) Patent Application Publication
(10) Pub. No.: US 2013/0140883 A1
(43) Pub. Date: Jun. 6, 2013

(54) VEHICLE POWER MANAGEMENT SYSTEM, VEHICLE POWER INFORMATION MANAGING APPARATUS AND VEHICLE ELECTRICAL LOAD

(71) Applicant: DENSO CORPORATION, Kariya-city (JP)

(72) Inventors: Atsuhito TAWADA, Kariya-shi (JP); Kunio KATOH, Nagoya (JP)

(73) Assignee: DENSO CORPORATION, Kariya-city (JP)

(21) Appl. No.: 13/705,521

(22) Filed: Dec. 5, 2012

(30) Foreign Application Priority Data
Dec. 5, 2011 (JP) 2011-265953

(51) Int. Cl. B60R 16/03; H02J 7/00

(52) U.S. Cl. CPC B60R 16/03; H02J 7/00
USPC 307/9.1

(57) ABSTRACT

A vehicle power management system judges whether or not a vehicle is in an excess energy state capable of generating an excess power in addition to a required generated power without consuming drive energy for running of the vehicle. If judged that the vehicle is in the excess energy state, first power value information is generated as power value information indicating a power value which is derived on the basis of a balance between a power supply and a power demand for the supplied power. In at least one of loads, when the first power value information is generated during operation of the load, a power consumption of the load is increased during a part or all of a period where the the first power value information is generated so as to be larger than a power consumption of the load immediately before the first power value information is generated.

### CROSS-REFERENCE TO RELATED APPLICATION

This application is based on and claims the benefit of priority from earlier Japanese Patent Application No. 2011-265953 filed Dec. 5, 2011, the description of which is incorporated herein by reference.

### BACKGROUND

1. Technical Field

The present invention relates to a vehicle power management system for managing electrical power that activates electrical loads in a vehicle, a vehicle power information managing apparatus that configures the system, and a vehicle electrical load.

2. Related Art

Vehicles in general have a generator and a battery. The battery is charged with the electrical power generated by the generator. The generated electrical power or the charged electrical power of the battery is supplied to the electrical loads (hereinafter just referred to as “loads”) so that the loads are activated.

In vehicles provided with an engine as a running power source, a generator is normally activated by the drive force of the engine (in other words, by the vehicle's consumption of fuel as drive energy in running (hereinafter just referred to as “drive energy”)) to generate electrical power. Therefore, as the power consumption of the loads as a whole becomes larger, or as the charging capacity of a battery becomes smaller, the fuel consumed for power generation becomes larger and increases fuel consumption (consumption of fuel needed for running a given distance) accordingly.

Recently, a variety of loads is installed in a vehicle and electrical power consumed by the loads has been steadily increasing. Therefore, there has been a need for decreasing fuel consumption (saving fuel consumption) or enhancing energy use efficiency (e.g., reducing emission of CO₂), while maintaining stable operation of the loads.

In contrast, recently, a so-called power regeneration technique is gradually proliferating. The power regeneration technique is used for vehicles having a battery. Specifically, with the regeneration technique, kinetic energy of such a battery-installed vehicle in run mode is used for operating a generator to thereby obtain a braking force and generate electrical power. Power generation based on regeneration is achieved using externally obtained kinetic energy (of the vehicle itself) without consuming fuel. Accordingly, positive use of power regeneration can lead to saving fuel consumption.

Electric vehicles have a motor, instead of an engine, as a running power source and thus have a battery (high-voltage battery) that activates the motor. Usually, the electrical power of the battery is used for activating loads in addition to activating the motor. Accordingly, as the power consumption of the loads as a whole becomes larger, power consumption of power from the battery (i.e. consumption of battery power as drive energy) also becomes larger.

Electric vehicles also use a power regeneration technique to charge the battery with the electrical power obtained by regeneration. Thus, in electric vehicles as well, positive use of power regeneration can lead to reducing consumption rate of battery power. Drive energy in electric vehicles is the battery power. Accordingly, reducing consumption rate of the battery power is equivalent to reducing fuel consumption in engine-installed vehicles. In the present specification, for the sake of convenience, the consumption rate of battery power in electric vehicles is referred to as “power consumption”. Also, reducing the consumption rate of battery power in electric vehicles is referred to as “power saving”.

Thus, a vehicle that uses power regeneration technique can effectively make use of the kinetic energy of the vehicle to perform power regeneration and realize consumption saving. However, depending on the conditions of the vehicle, the kinetic energy that should have been efficiently used (Le. that should have been regenerated) may be discarded without being converted to electrical power.

Specifically, for example, such conditions correspond to the case where the loads have already been supplied with necessary electrical power and the battery is in a state of being fully charged (or a state close to this). In this case, if generated power is further increased by power regeneration, the increased power remains as excess (surplus) power. Accordingly, in this case, the kinetic energy cannot be recovered (regenerated) any more, which means that the kinetic energy (excess energy) that should have been effectively used is externally discharged in the form of frictional heat caused by the application of braking. In this way, from the viewpoint of power saving, it is a loss to discard the kinetic energy unused, which should have been effectively used.

In this regard, a patent document JP-A-2004-254465 discloses a technique for appropriately processing the excess power obtained by regeneration. Specifically, when excess power is obtained as a result of power generation based on regeneration, power supply control means performs the following process. In the process, the power supply control means determines the loads by which the excess power should be consumed, based on the amount of the excess power and excess power absorption capability of the respective loads. The determination is notified to load control means arranged on the side of the loads, so that the load control means can deliver the excess power to the respective loads on the basis of the notification.

However, the technique disclosed in the above patent document involves provision of components (e.g., the load control means) in the paths for supplying power to the loads to appropriately deliver the excess power to the loads. Use of such components requires space and cost therefor and thus the system configuration will be more complicated.

Moreover, since the power supply control means has a large part of the responsibility of supplying excess power to the loads of the vehicle, delivery of excess power to the loads is predominated by the power supply control means. In other words, the power supply control means performs overall control, with supreme responsibility, for the supply of the excess power to the individual loads. Thus, the power supply control means has an extremely large influence on the individual loads.

Thus, in actually putting the power supply control means into production for installation to vehicles, it is required to obtain information regarding the essentials (important functional matters, spirit of the product, etc.) and the actual behaviors (behavioral specification, design, etc.) of the loads connected to the downstream side of the power supply paths, or to formulate the entire system after determining the loads that can accept the excess power or the extent of the excess power that can be accepted by the individual loads.

Specifically, in realizing the power supply control means, broad technical knowledge is required over the whole system including both of the supply and demand sides of the electrical power. Also, a large number of processes are involved in realizing the power supply control means. Therefore, actual realization of the power supply control means is difficult because there are great issues of ensuring the quality of the whole system and of reducing the cost incurred in the development. In particular, since vehicles are highly systematized in recent years, the electrical loads are mutually interdependent, and then realize a single function. Thus, it is difficult to use the power supply control means to totally control the system.

Further, each of the loads are structured to rely such as on the commands from an external unit i.e. the power supply control means), as to whether the excess power is required to be supplied to the load. Accordingly, each load is required to be designed taking into account the probability that a power-on state of the load may be suddenly (forcibly) switched to a power-off state, or vice versa, by the power supply control means.

Specifically, in designing or developing each load that is a passive and subordinate entity, the designer or the developer of the load is heavily compelled to take into account the probability of the load being strongly influenced by the power supply control means, but, on the other hand, to ensure safety and satisfy the functional requirements of the load equivalent to the conventional load.

### SUMMARY

The present disclosure provides a vehicle power management system, a vehicle power information managing apparatus, and a vehicle electrical load that can realize enhancement of power power saving function in a vehicle which is capable of power regeneration to more effectively use the kinetic energy of the vehicle at low-cost and with a simple configuration and with a process that can be easily introduced to the vehicle.

A first exemplary embodiment provides a vehicle power management system mounted in a vehicle. The vehicle includes: a plurality of electrical loads; a battery that supplies electric power to the electrical loads for driving the electrical loads; and a power generator that can generate electric power from torque of a wheel of the vehicle during running of the vehicle and, from the generated electric power, supplies a required electric power to the electrical loads while charging the battery to a predetermined target capacity. The power management system manages the electric power supplied to the electrical loads and includes an excess energy state judgment unit and a power value information generating unit.

The excess energy state judgment unit judges whether or not the vehicle is in an excess energy state which is capable of generating an excess power in addition to a required generated power without consuming drive energy for a running of the vehicle. The required generated power is an electric power needed to be currently generated. The excess power is an excess available power exceeding the required generated power.

The power value information generating unit generates power value information indicating a power value which is derived on the basis of a balance between a power supply and a power demand for the electric power supplied from at least one of the power generator and the battery to the electrical loads. If judged that the vehicle is in the excess energy state, the power value information generating unit also generates, as the power value information, first power value information indicating a first power value which is the power value when the vehicle is in the excess energy state. This first power value is set to be lower than a second power value which is the power value when the vehicle is not in the excess energy state.

At least one of the electrical loads is configured to be responsive to an increase in the electric power, and includes a power consumption increasing unit. When the first power value information is generated by the power value information generating unit during operation of the load, the power consumption increasing unit increases a power consumption of the load during a part or all of a period where the the first power value information is generated so as to be larger than a power consumption of the load immediately before the first power value information is generated.

The power generator generates power to meet the demanded power of the plurality of electrical loads. Thus, when the load attempts to increase power consumption using the power consumption increasing unit, the power generator also increases generated power accordingly.

The drive energy of a vehicle refers to energy required for running the vehicle. For example, in a vehicle provided with an internal combustion engine as a running power source, the drive energy refers to the fuel used for the internal combustion engine. Also, in a vehicle provided with a motor as a running power source, the drive energy refers to the battery power used for activating the motor.

Further, the required generated power refers to a total amount of power to be generated by the power generator. Thus, the required generated power depends on the power consumption (demand of power) in a vehicle. For example, as the entire power required for activating the electrical loads becomes larger, the required generated power also becomes larger. For example, as the charging capacity of a battery becomes smaller than a target capacity, the required generated power becomes larger.

In the vehicle power management system configured in this way, supply of excess power to the electrical loads is not dominated such as by a control unit as in the conventional art. Instead, the individual electrical loads are able to independently determine whether to receive the excess power (i.e. whether to increase power consumption).

Specifically, when the vehicle is in an excess energy state, the power value information producing unit produces power value information indicating accordingly, i.e. produces first power value information. More specifically, the power value information producing unit notifies the electrical loads of information that the value of the power value (i.e., first power value) when the vehicle is in an excess energy state is relatively low compared to that of the power value (i.e., second power value) when the vehicle is not in the excess energy state, and that, accordingly, the electrical loads may consume power larger than the power consumed in the normal operation (that the vehicle is in a state where power can be excessively generated and supplied, i.e. power larger than the normally required power can be generated).

Of the electrical loads, the loads are able to increase their power consumption when the first power value information is produced. When the first power value information is produced, the amount of power to be actually consumed, the period of actually increasing power, and the like can be appropriately determined by each of the loads. As a result of increasing power consumption during the period when the first power value information is produced, power saving function of the vehicle is enhanced. The reasons are set forth below.

When power consumption is increased while the first power value information is produced, the effects (actual effects) of the loads in operation can be more exerted than in the normal operation.

For example, let us take the case, as an example, where an air conditioner as an example of the loads is in operation and the blower of the air conditioner is operated at a high output level so as to decrease the temperature of the vehicle interior to a level set by the user. In this case, power consumption is temporarily increased while the first power value information is produced to operate the blower such that air is blown much stronger than in the high-output-level operation. Thus, accordingly, the temperature of the vehicle interior nears the set temperature more promptly than in the normal operation (i.e. in the case where power consumption is not increased).

Therefore, after the power consumption has been returned to the normal power consumption following the completion of producing the first power value information (i.e. after the output level has again been changed to a high output level), the set temperature is reached more promptly than in the case where power consumption has not been increased. This reduces consumption, accordingly, of the drive energy used for generating power with which the blower is operated. Moreover, the increase of power consumption during the period of producing the first power value information is covered by the power generation based on a different energy source (e.g., kinetic energy of the vehicle), without consuming the drive energy of the vehicle.

Specifically, when excess energy is available (when the vehicle is in a state where power can be generated more than necessary, if needed, using the kinetic energy or the like of the vehicle without consuming the drive energy), an excess power is generated using the excess energy to thereby increase power consumption of the loads. This can decrease subsequent power consumption of the loads compared to normal operation, and further, can decrease consumption of the drive energy required for power generation. As a result, overall, power saving function of the vehicle is enhanced.

Unlike the conventional art, the present embodiment can eliminate components for appropriate delivery of excess power to the loads, in power supply paths directed to the loads. Further, the excess power in the loads is independently consumed (power consumption is increased) by the loads. Accordingly, it is no longer necessary to obtain detailed information regarding the individual electrical loads, in configuring the power value information producing means. Thus, developers of the electrical loads are ensured to have a degree of freedom in designing the control of power consumption and can work on the development of the loads.

In this way, the vehicle power management system set forth above is able to more effectively use the kinetic energy of a vehicle with a simple configuration and at low cost, and with a process that can be easily installed in a vehicle. Thus, the power saving function of the vehicle is more enhanced.

The power consumption of the load may be increased by the power consumption increasing unit when generation of the first power value information is started during operation of the load, and may be subsequently decreased during a predetermined period so as to be lower than a power consumption before the generation of the first power value information, when the generation of the first power value information is completed.

As set forth above, increase of power consumption in a period when the first power value information is produced can enhance accordingly the efficiency of the operation of the loads. Thus, if power consumption is decreased for a predetermined period following completion of producing the first power value information, the effects of the loads are equivalent, overall, to the case where the loads would have been continuously operated in the normal operation mode with no increase of power consumption. Taking again the air conditioner as an example, the output of the blower is increased during the period of the excess energy state to more promptly achieve a temperature approximate to a set temperature. Then, the output of the blower is decreased accordingly for a predetermined period following the period of the excess energy state (e.g., air blow is set to a weak level at which less power is consumed than at a strong level). In this way of consuming power as well, a set temperature is resultantly reached in a time equivalent to the case where the loads would have been continuously operated in the normal operation mode. Thus, the power saving function of the vehicle is more reliably enhanced.

In the vehicle power management system, power-increase-ability information may be set in advance in the load. The power-increase-ability information is a reference in judging whether or not the power consumption increasing unit can increase the power consumption on the basis of the value indicated by the first power value information. The vehicle power management system further comprises a power-increase judgment unit that judges whether or not the power consumption increasing unit can increase the power consumption by comparing the power-increase-ability information with the first power value information, and that increases the power consumption if judged that the power consumption increasing unit can increase the power consumption.

Specifically, it is not that, even when the vehicle is in the excess energy state, all the loads are ensured to unconditionally increase power consumption. Instead, each of the loads compares power-increase-ability information set to itself with the first power value information and, on the basis of which, determines whether increase of power consumption is possible. This attitude, in other words, is based on a concept that the loads having a higher ability of increasing power consumption can preferentially consume the excess power. Thus, an appropriate excess power suitable for the first power value information can be delivered to each of the loads.

The vehicle power management system may further comprise a demanded power detector that detects a demanded power which is an electric power actually consumed by the plurality of the electrical loads. The power value information generating unit may generate the first power value information such that the lower the demanded power the lower the first power value when the vehicle is in the excess energy state.

Producing the first power value information in this manner leads to production of first power value information including an appropriate value suitable for an actually consumed power (demanded power). Thus, as the actually consumed power becomes smaller, the more number of loads are encouraged to increase power consumption.

If judged that the vehicle is in the excess energy state, the excess energy state judgment unit may perform an excess power judgment which is a judgment of how much excess power can be generated without consuming the drive energy for the running of the vehicle. The power value information generating unit may generate the first power value information such that the larger the excess power the lower the first power value on the basis of the amount of the excess power which is judged by the excess power judgment performed by the excess energy state judgment unit.

Producing the first power value information in this manner, as the potential excess power becomes larger, the value of the power supplied to the loads can be lowered more. Thus, the more number of loads are encouraged to consume power.

The excess energy state judgment unit may judge that the vehicle is in the excess energy state, when (i) the battery is charged to the target capacity, and (ii) a braking of the vehicle is applied, during running of the vehicle.

In the first exemplary embodiment, the state where the battery has been charged to a target capacity with the braking of the vehicle means that the vehicle is in a state where an increased generated power, if it is obtained using the kinetic energy of the vehicle, is of no use. In this case, it is determined that the vehicle is in the excess energy state and power value information (first power value information) indicating accordingly is produced. Thus, the kinetic energy of the vehicle when braking is applied (the energy that would have been discarded in the form of heat in the conventional art) can be effectively used.

A second exemplary embodiment provides a vehicle power information managing apparatus mounted in a vehicle. The vehicle includes: a plurality of electrical loads; a battery that supplies electric power to the electrical loads for driving the electrical loads; and a power generator that can generate electric power from torque of a wheel of the vehicle during running of the vehicle and, from the generated electric power, supplies a required electric power to the electrical loads while charging the battery to a predetermined target capacity.

The power information managing apparatus manages the electric power supplied to the electrical loads and includes an excess energy state judgment unit, a power value information generating unit, and a sending unit.

The excess energy state judgment unit judges whether or not the vehicle is in an excess energy state which is capable of generating an excess power in addition to a required generated power without consuming drive energy for a running of the vehicle. The required generated power is an electric power needed to be currently generated. The excess power is an excess available power exceeding the required generated power.

The power value information generating unit generates power value information indicating a power value which is derived on the basis of a balance between a power supply and a power demand for the electric power supplied from at least one of the power generator and the battery to the electrical loads. If judged that the vehicle is in the excess energy state, the power value information generating unit also generates, as the power value information, first power value information indicating a first power value which is the power value when the vehicle is in the excess energy state. This first power value is set to be lower than a second power which is the power value when the vehicle is not in the excess energy.

The sending unit sends the first power value information generated by the power value information generating unit to at least one of the electrical loads which is configured to be responsive to an increase in the electric power.

The vehicle power information managing apparatus configured in this way is able to realize the vehicle power management system set forth above. In the realized system, the advantages and effects similar to set forth above are obtained.

A third exemplary embodiment provides a vehicle electrical load mounted in a vehicle. The vehicle includes: a battery; and a power generator that can generate electric power from torque of a wheel of the vehicle during running of the vehicle and, from the generated electric power, supplies a required electric power to a predetermined supplied object while charging the battery to a predetermined target capacity.

The electrical load is activated by electric power supplied from the battery or the power generator. The electrical load is configured to: (a) receive power value information indicating a power value which is derived on the basis of a balance between a power supply and a power demand for the supplied electric power; and (b) receive first power value information as the power value information, when the vehicle is in an excess energy state which is capable of generating an excess power in addition to a required generated power without consuming drive energy for a running of the vehicle. The required generated power is an electric power needed to be currently generated. The excess power is an excess available power exceeding the required generated power. The first power value information indicates first power value which is the power value when the vehicle is in the excess energy state. This first power value is set to be lower than a second power value which is the power value when the vehicle is not in the excess energy state. The electrical load includes a power consumption increasing unit that, when the first power value information is received during operation of the load, increases a power consumption of the load during a part or all of a period where the the first power value information is received so as to be larger than a power consumption of the load immediately before the first power value information is received.

The vehicle electrical loads configured in this way can realize the vehicle power management system set forth above. In the realized system, the advantages and effects similar to set forth above are obtained.

### BRIEF DESCRIPTION OF THE DRAWINGS

In the accompanying drawings:

FIG. 1 is a schematic diagram illustrating a configuration of a power management system according to a first embodiment of the present invention;

FIG. 2 is a schematic diagram specifically illustrating a configuration of a heating/air-conditioning system load group illustrated in FIG. 1;

FIG. 3 is a schematic diagram illustrating a configuration of loads composing the heating/air-conditioning system load group illustrated in FIG. 1;

FIGS. 4A to 4C illustrate power value rate tables stored in a power manager illustrated in FIG. 1, the tables being used in a non-excess energy state;

FIG. 5 illustrates a power value rate table D stored in the power manager illustrated in FIG. 1, the table being used in an excess energy state;

FIGS. 6A and 6B each illustrate a relationship between power value transmitted to the loads illustrated in FIG. 1 and power purchasing ability set in the loads;

FIG. 7 is a flow diagram illustrating a power value calculation/output process performed by the power manager illustrated in FIG. 1;

FIG. 8 is a flow diagram illustrating an operation mode determination process performed by the heating/air-conditioning system load group (excepting a cooling box) illustrated in FIG. 1; and

FIG. 9 is a schematic diagram illustrating a power management system according to a second embodiment of the present invention.

### DETAILED DESCRIPTION OF THE PREFERRED EMBODIMENTS

With reference to the accompanying drawings, hereinafter are described some embodiments of the present invention.

### First Embodiment

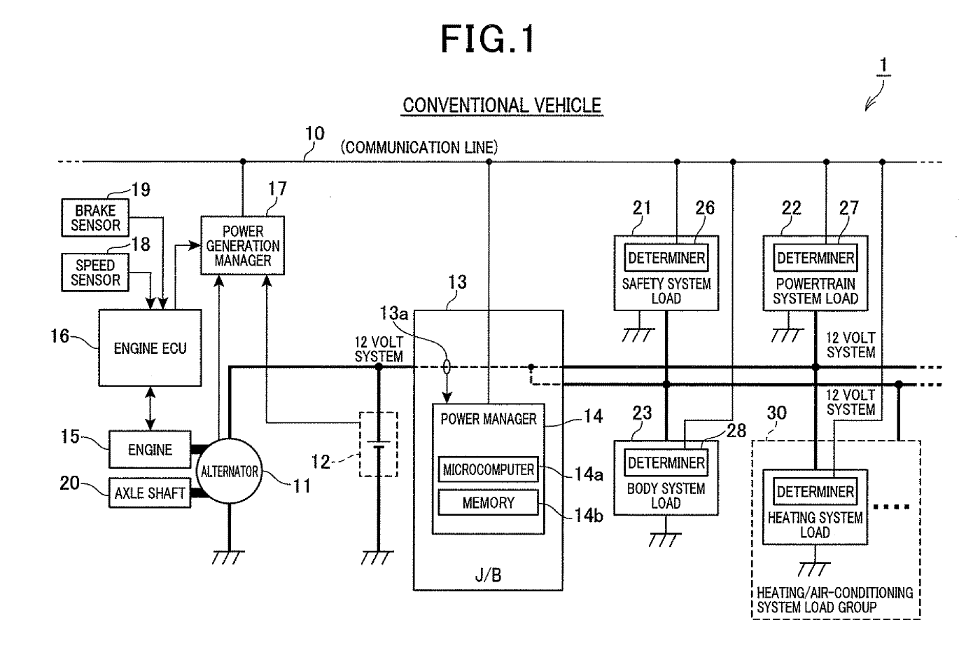

Referring to FIGS. 1 to 8, a first embodiment of the present invention is described. FIG. 1 is a schematic diagram illustrating a power management system (corresponding to a vehicle power management system) 1 according to the first embodiment. The power management system 1 is installed in a conventional vehicle that runs using an engine (internal combustion engine) 15, such as a gasoline engine or a diesel engine, as a power source for running to manage electrical power supplied to a plurality of electrical loads (hereinafter also just referred to as “loads”) installed in the vehicle. The drive force generated by the engine 15 is transmitted to an axle shaft 20 via a power transmission mechanism, such as a change gear, not shown. Thus, wheels provided at the ends of the axle shaft 20 are rotated to run the vehicle.

The power management system 1 includes a alternator 11, a battery 12, a plurality of loads 21, 22 and 23, a heating/air-conditioning system load group 30, a junction box (J/B) 13 and a power manager (corresponding to a vehicle power information managing apparatus) 14. The alternator 11 is a well-known alternator and generates power using the drive force of the engine 15 or the torque of the axle shaft 20 (i.e. torque of the wheels). The battery 12 stores the power generated by the alternator 11. The loads 21 correspond to safety system loads. The loads 22 correspond to powertrain system loads. The loads 23 correspond to body system loads. The heating/air-conditioning system load group 30 is configured by a plurality of loads 31, 32, 33, 34, 35, 36 and 37. The loads 21, 22 and 23 and the loads in the heating/air-conditioning system load group 30 (hereinafter these loads are collectively also just referred to as “a plurality of loads” or “the loads”) are activated by the power generated by the alternator 11 or the power stored in the battery 12. The junction box (J/B) 13 delivers the power from the alternator 11 or the battery 12 to the plurality of loads. The power manager 14 is disposed in the JIB 13 to produce information regarding the power to be supplied to the loads and transmit the produced information to the loads.

The engine 15 is controlled by an engine ECU 16. The engine ECU 16 also has a function of detecting and outputting a fuel consumption of the engine 15 to a power generation manager 17.

The vehicle includes a speed sensor 18 and a brake sensor 9. The speed sensor 18 detects a running speed of the vehicle and transmits the detection results to the engine ECU 16. The brake sensor 19 detects a driver's predetermined braking manipulation (e.g. manipulation of pressing a foot brake) and a manipulated variable of the braking manipulation (e.g. an amount of pressing the foot brake, or, in other words, a braking intensity) and transmits the detection results to the engine ECU 16.

The engine ECU 16 controls the engine 15 based on the pieces of information transmitted from the speed sensor 18 and the brake sensor 19. Also, the engine ECU 16 has a function of determining a running state of the vehicle (whether the vehicle is in a state of acceleration, constant-speed running or deceleration) based on the information from the speed sensor 18 and periodically outputting the results of the determination to the power generation manager 17. The engine ECU 16 also has a function of periodically outputting a braking intensity transmitted from the brake sensor 19 to the power generation manager 17.

The power generation manager 17 has a fundamental function of controlling the generation operation of the alternator 11, i.e. controlling charge of the battery 12 and supply of power to the loads performed by the alternator 11. Accordingly, the power generation manager 17 monitors various states, such as SOC (state of charge) or SOH (state of health), of the battery 12. For example, when SOC is lowered, under the control of the power generation manager 17, the alternator 11 is operated to generate power. Due to this generated power, the battery 12 is charged to a predetermined SOC (target capacity). Further, under the control of the power generation manager 17, the alternator 11 is operated in response to the power demands of the loads to supply required power to the loads.

Furthermore, the power generation manager 17 of the present embodiment periodically calculates a generation cost that indicates the cost of generation performed by the alternator 11. The generation cost indicates the cost required for generating power to be supplied to the loads and the battery 12. The generation cost is outputted as an electricity cost to the power manager 14.

In the present embodiment, the generation cost (=electricity cost in the present embodiment) is expressed by a fuel consumption (g/h/kW=g/kWh) per unit generated power. Accordingly, the electricity cost is high at the time of acceleration or idling, but low at the time of deceleration. Fuel consumption at the time of cruising is approximately at the midpoint between acceleration and deceleration. Accordingly, the electricity cost during cruising is also approximately at the midpoint between acceleration and deceleration.

Thus, the power generation manager 17 periodically calculates an electricity cost and transmits the calculated electricity cost to the power manager 14 via a communication line 10.

The power generation manager 17, periodically monitoring the states, such as SOC and SOH, of the battery 12, also transmits information indicating battery states to the power manager 14 via the communication line 10. Further, the power generation manager 17 also periodically (e.g., every time an input is received from the engine ECU 16) transmits to the power manager 14 a running state (whether the vehicle is in a state of deceleration or not, in particular) and a braking intensity inputted from the engine ECU 16.

In the present embodiment, the power generation manager 17 is described as being configured to be independent of the engine ECU 16 and the like. However, this is only an example and thus the position where the power generation manager 17 is actually installed in a vehicle may be determined as appropriate. For example, the power generation manager 17 may be incorporated into the engine ECU 16 or the power manager 14. Also, whether the functions of the power generation manager 17 are realized with software or hardware (e.g., logic circuit) may also be determined as appropriate,

The battery 12 is a well-known battery that stores power of DC 12 V and supplies the power to the loads such as when the alternator 11 is not in operation. The battery 12 is charged by the alternator 11 under the control of the power generation manager 17 so that the predetermined SOC (target capacity) is achieved.

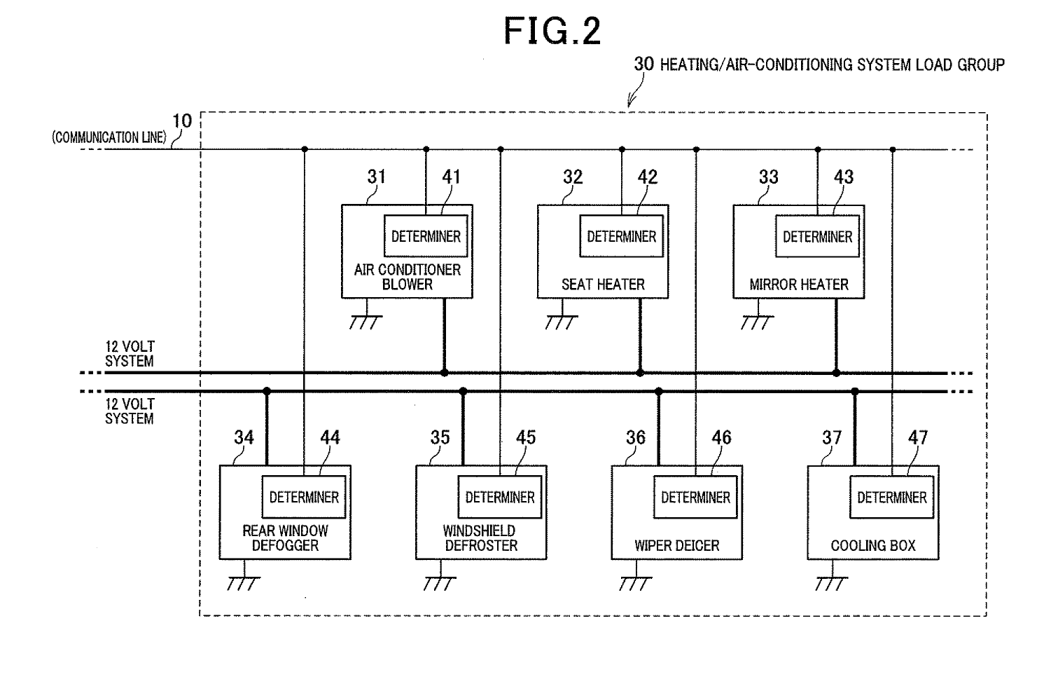

The electrical loads correspond to so-called “auxiliary machines (or auxiliary machinery)” which are activated with the DC 12 V power supplied from the battery 12. A number of auxiliary machines are available for installation in a vehicle. In the present embodiment, in order to simplify the explanation, the illustration in the figures includes only the safety system loads 21, powertrain system loads 22, the body systems loads 23 and seven heating/air-conditioning system loads 31, 32, 33, 34, 35, 36 and 37 (see FIG. 2).

The safety system loads 21 may specifically include a brake ECU and an electric power steering apparatus. The powertrain system loads 22 may specifically include loads, such as an engine ECU, that control the powertrain of a vehicle. The body system loads 23 may specifically include a door ECU, a power window and a meter ECU.

As shown in FIG. 2, the heating/air-conditioning system load group 30 is specifically composed of an air conditioner blower 31, seat heater 32, mirror heater 33, rear window defogger 34, windshield defroster 35, wiper deicer 36, cooling box 37 and the like.

The air conditioner blower 31 is a component that configures an air conditioner and has a function of conditioning temperature of the vehicle interior. For example, the air conditioner blower 31 is mounted to an air conditioner outlet which is arranged in an instrument panel of the vehicle interior. When the air conditioner is in an automatic mode, airflow control of the air blown from the air conditioner blower 31 is automated based on the difference between a set temperature and an actual temperature of the vehicle interior. For example, when the temperature difference is large, the airflow is set to a high level, but when small, set to a low level. When the temperature difference is not large but not small, the airflow is set to a middle level. When the air conditioner is in a manual mode, the air conditioner blower 31 operates at an airflow level that has been set such as by the driver. In a normal operation, the airflow of the air conditioner blower 31 is set to any one of the high, middle and low levels. However, only in a special case (when the air conditioner is in a positive power-usage mode as described later), the airflow is automatically set to an “extra high” level at which an airflow stronger than at the “high” level is achieved. Specifically, airflow will not be set to “extra high” in normal operation but is ensured to be exceptionally set to “extra high” in the special case. As a matter of course, stronger airflow consumes more power.

The seat heater 32 controls temperature of a seating surface and/or a back surface of a seat and is arranged at the seating surface and/or the back surface of the seat. Temperature can be automatically or manually controlled by the seat heater 32. For example, temperature may be set to any one of three levels, i.e. a “low” level at which the generated heat is small, a “high” level at which the generated heat is large and a “middle” level at which the generated heat is intermediate. Only in a special case (when the air conditioner is in a positive power-usage mode as described later), temperature is automatically set to an “extra high” level at which a temperature higher than at the “high” level is achieved. Again, the temperature will not be set to “extra high” in normal operation but is ensured to be exceptionally set to “extra high” in the special case. As a matter of course, larger generated heat consumes more power.

The mirror heater 33 has a function of melting water droplets or snow formed or fell on a door mirror and thus is arranged at the surface of a door mirror. In the present embodiment, similar to the seat heater 32, temperature of the mirror heater 33 can be automatically or manually set to any one of three levels. Also, in a special case, temperature is automatically set to an “extra high” level at which a temperature higher than at a “high” level is achieved.

The rear window defogger 34 has a function of defogging a rear window and thus is configured by laying heater wires over the entire rear window. In the present embodiment, similar to the seat heater 32, temperature of the rear window defogger 43 can be automatically or manually set to any one of three levels. Also, in a special case, temperature is automatically set to an “extra high” level at which a temperature higher than at a “high” level is achieved.

The windshield (front window) defroster 35 has a function of defrosting a windshield and thus is arranged at a lower portion of the windshield. The windshield defroster 35 is configured so that hot air is blown toward the windshield. In the present embodiment, similar to the air conditioner blower 31, airflow of the windshield defroster 35 can be automatically or manually set to any one of three levels. Also, in a special case, airflow is automatically set to an “extra high” level at which an airflow stronger than at a “high” level is achieved.

The wiper deicer 36 has a function of preventing wipers from freezing (preventing wipers from becoming unmovable due to freezing) and thus is configured by laying heater wires at a lower portion of the windshield. Ice or snow formed or falling in the vicinity of the wipers is ensured to be melted by the heater wires so that the wipers can move. In the present embodiment, similar to the seat heater 32, temperature or the wiper deicer 36 can be automatically or manually set to any one of three levels. Also, in a special case, temperature is automatically set to an “extra high” level at which a temperature higher than at a “high” level is achieved.

The cooling box 37 has a function of refrigerating or cooling contents in the box and is arranged, for example, rear of a rear center armrest in the vehicle interior. The cooling box 37 is configured to be turned on/off in a manual manner.

Each safety system load 21, each powertrain system load 22 and each body system load 23 includes determiners (corresponding to power consumption increasing units and power-increase judgment units) 26, 27 and 28, respectively. The loads 31, 32, 33, 34, 35, 36 and 37 composing the heating/air-conditioning system load group 30 also include determiners (corresponding to power consumption increasing units and power-increase judgment units) 41, 42, 43, 44, 45, 46 and 47, respectively. Each of the determiners receives a power value (described later) transmitted from the power manager 14 via the communication line 10. Based on the power value and the power purchasing ability of itself, each determiner determines whether the mode of the load should be changed to a power-saving mode or a positive power-usage mode and then carries out power consumption control according to the results of the determination.

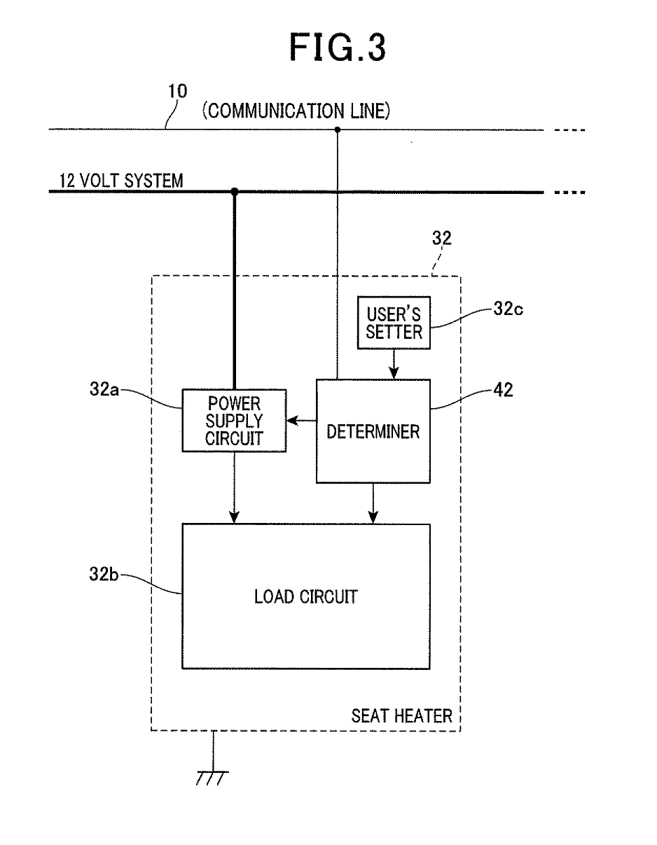

Referring to FIG. 3, hereinafter are described specific configurations of the loads. FIG. 3 shows, as a representative, a configuration of the seat heater 32 of the heating/air-conditioning system load group 30. As shown in FIG. 3, the seat heater 32 includes a load circuit 32b, a power supply circuit 32a, a user's setter 32c and the determiner 42. The load circuit 32b essentially operates as a load (receives a supply of power and generates heat). The power supply circuit 32a receives a power of DC 12 V and generates an operation power for the load circuit 32b from the received power and supplies the generated operation power to the load circuit 32b. The user's setter 32c is manipulated by the user to give information regarding whether transition to a power-saving mode or a positive power-usage mode is permitted.

The power supply circuit 32a and the determiner 42 consume a little power for their operation, but the majority of the power in the seat heater 32 is consumed by the load circuit 32b.

The determiner 42 determines whether a power value transmitted from the power manager 14 is positive or negative. When the power value is positive, the determiner 42 compares the positive power value (corresponding to a second power value) with the power purchasing ability (corresponding to the positive power value) of the seat heater 32. If the power value is higher than the power purchasing ability, the determiner 42 allows the seat heater 32 to transit to a power-saving mode. Then, the determiner 42 outputs a command to either or both of the power supply circuit 32a and the load circuit 32b for decrease of power consumption or completely stop operation of the circuit 32a and/or the circuit 32b. Thus, power consumption of the seat heater 32 is decreased.

However, based on first user-set information which is set (inputted) by the user via the user's setter 32c, the determiner 42 may inhibit transition to the power-saving mode but may allow the seat heater 32 to constantly operate with normal power consumption (to be in normal operation). Specifically, when the first user-set information is available, it means that transition to the power-saving mode is allowed. When the first user-set information is not available, it means that transition to the power-saving mode is inhibited.

When the power value transmitted from the power manager 14 is negative, the determiner 42 compares the negative power value (first power value) with the power purchasing ability (corresponding to the negative power value) of the seat heater 32. If the power purchasing ability is higher than the power value, the determiner 42 allows the seat heater 32 to transit to a positive power-usage mode. Then, the determiner 42 outputs a command to either or both of the power supply circuit 32a and the load circuit 32b for increase of power consumption of the seat heater 32. Specifically, in the present embodiment, when the level of the generated heat is set to a “high” level, the mode of the seat heater 32 is changed to the positive power-usage mode to switch the output (generated heat) from the “high” level to an “extra high” level.

However, based on second user-set information which is set (inputted) by the user via the user's setter 32c, the determiner 42 may inhibit transition to the positive power-usage mode but may allow the seat heater 32 to constantly operate with normal power consumption (to be in normal operation). Specifically, when the second user-set information is available, it means that transition to the positive power-usage mode is allowed. When the second user-set information is not available, it means that transition to the positive power-usage mode is inhibited.

Thus, with the change of the power value transmitted from the power manager 14 from positive to negative, the determiner 42 allows the operation mode to transit to the positive power-usage mode. However, after that (i.e. after increasing output), the power value may again be changed to negative. In such a case, the determiner 42 allows the seat heater 32 to operate, for a predetermined set period, with a small output which is smaller than the output in the normal operation, instead of immediately allowing the seat heater 32 to return to the normal operation. Thus, power consumption of the seat heater 32 is decreased compared to the normal operation. For example, when the level of generated heat is switched from “high” to “extra high” with the change of the power value from positive to negative, and when this is followed by the change of the power value to positive again, the level of the generated heat is not simply switched to “high” again but switched to “middle” or “low”, for a predetermined period, at which the output (power consumption) is smaller than at the “high” level.

The determiner 42 may be configured by a microcomputer to carry out the various processes with software. Alternatively, the determiner 42 may be configured by hardware, such as a logic circuit.

Similar to the seat heater 32, other loads 31 and 33 to 37 that compose the heating/air-conditioning system load group 30 include respective power supply circuits and user's setters. Thus, in each of these loads as well, the user can set whether the operation mode should be changed to the power-saving mode or the positive power-usage mode. Specific processes of decreasing power in the power-saving mode and specific processes of increasing output (increasing power consumption) in the positive power-usage mode are also similar to those in the seat heater 32.

In the loads 21, 22 and 23, as well, other than the loads of the heating/air-conditioning system load group 30, the basic configuration is similar to the seat heater 32 shown in FIG. 3, except that the function of transiting to the positive power-usage mode is not available in the loads 21, 22 and 23. Specifically, the loads 21, 22 and 23 are configured such that their operation mode is changed to the power-saving mode according to the power value.

The J/B 13 has a function of relaying/delivering power supplied from the alternator 11 and the battery 12 to the loads. In the present embodiment, a power of DC 12 V is divided for use in two systems for supply to the loads.

The power manager 14 provided in the J/B 13 manages power to be supplied to the loads. In the present embodiment, instead of positively controlling supply of power to the loads, the power manager 14 plays a role of just producing power information (corresponding to the power value information), i.e. a power value that is a piece of information indicating the value of the power to be supplied, and transmitting the produced power value to the loads. The power value in the present embodiment basically has a positive value, excepting the case of an excess energy state described later.

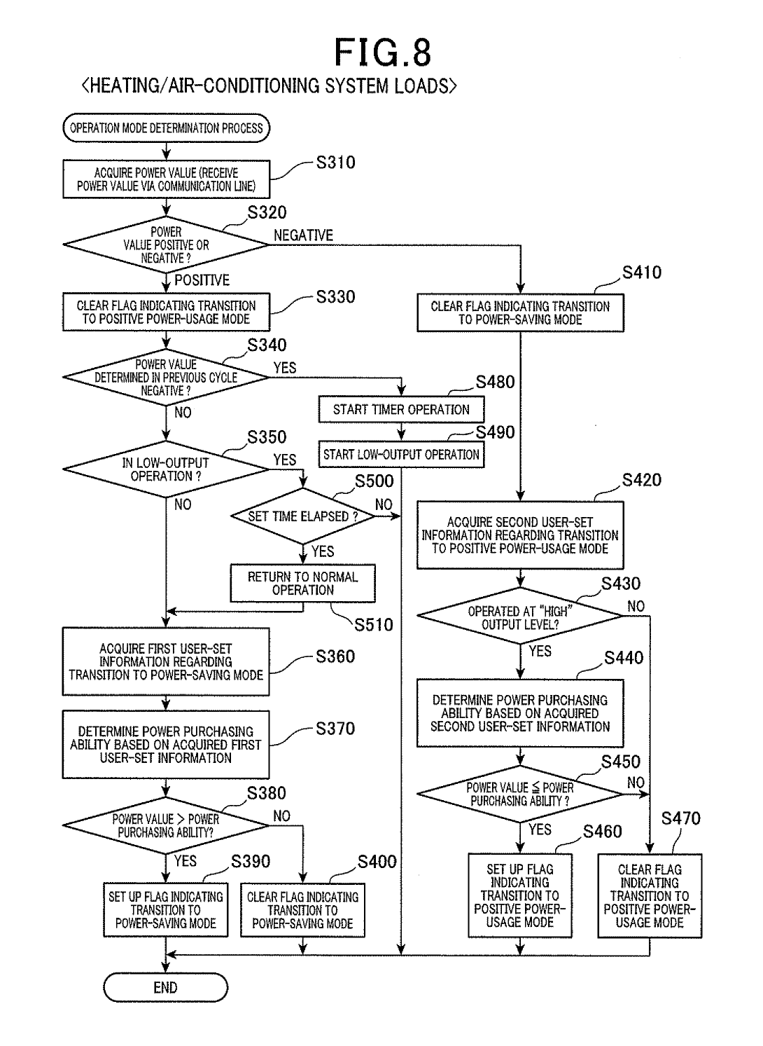

The power manager 14 includes a microcomputer 14a and a memory 14b and carries out a power value calculation/output process (see FIG. 8), for example, which will be described later, according to a program stored in the memory 14b. In this embodiment, the microcomputer 14a and the memory 14b are configured to function as an excess energy state judgment unit, a power value information generating unit, a sending unit, and a demanded power detector.

The power information (i.e., power value) produced and transmitted by the power manager 14 corresponds to a current value of power. Specifically, the power information indicates a value of a power (power value) which is derived on the basis of a balance between a power supply side (generation side) and a power demand side (load side). More specifically, the power value is derived based on how much power is in demand currently (demand side status) and how much the generation cost (electricity cost) currently is (supply side status).

Regarding the supply side status, the power value and the electricity cost are correlated to each other. When the electricity cost is high, the power value also becomes high and when the electricity cost is low, the power value also is low. As mentioned above, an electricity cost (generation cost) calculated by the power generation manager 17 is periodically transmitted to the power manager 14. Accordingly, an electricity cost and the level of the electricity cost (whether it is high, low or middle) can be acquired by receiving transmission of the electricity cost. As the electricity cost is higher, the power value is also ensured to be set to a higher value.

Regarding the demand side status, in the present embodiment, the power manager 14 is ensured to detect a total amount of power required by the loads, i.e. the power consumption of all of the loads of an auxiliary machine system and to reflect the detected power consumption to the production of a power value. Specifically, the J/B 13 is provided with a current sensor 13a that detects a total power to be supplied to the loads from the alternator 11 and the battery 12. Detection signals of the current sensor 13a are configured to be inputted into the power manager 14.

What is directly detected by the current sensor 13a is a current consumption. When a current consumption is obtained, a power consumption can be calculated based such as on the rating of the battery 12, which is 12 V. Alternatively, a wattmeter may be provided instead of the current sensor 13a to directly detect a power consumption. Alternatively, other processes may be used to detect a power consumption of the auxiliary machine system as a whole.

Thus, the power manager 14 is able to acquire the power consumption of the loads (power consumption of the auxiliary machine system as a whole) based on a detection signal from the current sensor 13a. The acquired power consumption is reflected in the production of a power value. For example, when the power consumption is large (i.e. demand is large), the power value is high and when the power consumption is small (i.e. demand is small), the power value is low. In other words, it is so configured that as the power consumption (demanded power) becomes larger, the value of the power (power value) to be supplied becomes higher.

Further, in the present embodiment, storage side status (i.e. status of the battery 12) is also considered in addition to the supply side status and the demand side status to produce a power value. As mentioned above, the power generation manager 17 transmits the acquired information indicating a battery state, such as SOC and SOH, to the power manager 14 via the communication line 10.

The power manager 14 reflects the battery state transmitted from the power generation manager 17 to the production of a power value. For example, when the health and charge of the battery are both bad as indicated by the SOH and SOC, the power manager 14 determines that the battery 12 is deteriorated. Thus, the power value is set to a slightly higher value. On the other hand, when the SOH and SOC show that the battery's health and charge are both good, the power manager 14 determines that the battery 12 is in a good condition. Thus, the power value is set to a little lower value.

When the battery 12 is in a good condition and the SOC indicates, in particular, that the battery is well charged to reach a target capacity (i.e. fully charged), the power manager 14 determines that the battery 12 is in a very good condition. In this case, however, the power value in the present embodiment is basically equal to the power value when the battery 12 is in a good condition.

However, when the battery 12 is in a very good condition, while the vehicle is decelerated and the electricity cost is low, and braking is applied in addition, the vehicle is able to use its kinetic energy without consuming fuel. Specifically, using the kinetic energy, the vehicle is able to generate not only the required power that should be generated currently but also a power exceeding the required power (excess power). In this case, the vehicle is in an excess energy state.

The kinetic energy of the vehicle when the vehicle is decelerated by the driver's application of braking is basically discharged as heat energy (braking heat). In the present embodiment, the braking heat is used to generate power with the alternator 11 and the generated power is supplied to the loads and charged to the battery 12. Specifically, the kinetic energy of the vehicle at the time of deceleration is converted to heat energy and regenerative energy. This does not mean that only the conversion into heat energy is preferentially conducted and conversion into regenerative energy is conducted only when the conversion into heat energy has exceeded its convertible limit. In other words, this does not mean that the power generation manager 17 carries out power regeneration with the alternator 11 only when all the kinetic energy of the vehicle at the time of deceleration can no longer be converted into heat energy. Instead, the power generation manager 17, when it detects that the brake pedal has been pressed, coordinates with the brake (conversion into heat energy) to control power regeneration of the alternator 11, so that the regenerative energy can be maximally used.

Therefore, when the battery 12 is in a very good condition (fully charged), the condition where the vehicle is in deceleration with the brake being pressed means that power more than necessary (excess power) can be generated, if needed, using kinetic energy of the vehicle (i.e. without consuming fuel) but that there is no way of using the excess power (the condition corresponds to the excess energy state).

Thus, if the electricity cost transmitted from the power generation manager 17 is low, the power manager 14 determines whether the vehicle is being decelerated, whether the battery 12 is in a very good condition (fully charged) and whether the brake pedal has been pressed, based on other various pieces of information also transmitted from the power generation manager 17. Then, if the vehicle is being decelerated, the battery 12 is in a very good condition and the brake pedal has been pressed, the power manager 14 determines that the vehicle is in the excess energy state (i.e., a state where excess power can be generated) to thereby set a negative value (lowest value corresponding to first power value indicated by first power value information) as a power value (indicated by power value information). The specific value to be set depends on the braking intensity and the power consumption of the loads. This will be described later.

Reflecting both of SOC and SHO in determining the state of the battery 12 is only an example. For example, either SOC or SOH may be reflected to the power value. Specifically, when only SOC is reflected, if a nearly fully charged state is indicated by the SOC, for example, the power manager 14 determines that the battery 12 is in a “good condition” (“very good condition” if a fully charged state is indicated), i.e. a state where a plenty of dischargeable power is available and there is a low necessity of charging the battery 12 (charging is not required in the “very good condition”). Thus, the power value is set to a little lower value. On the other hand, if a state of charge with a small volume is indicated by the SOC, the power manager 14 determines that the battery 12 is “deteriorate”, i.e., in an over-discharged state where there is a high necessity of charging the battery 12. Thus, the power value is set to a little higher value. Briefly, it is preferable that, as a SOC indicates a state of charge with a smaller volume (smaller remaining capacity), or as a SOH indicates a state of lower health (more serious deterioration), the power value is set to a higher value.

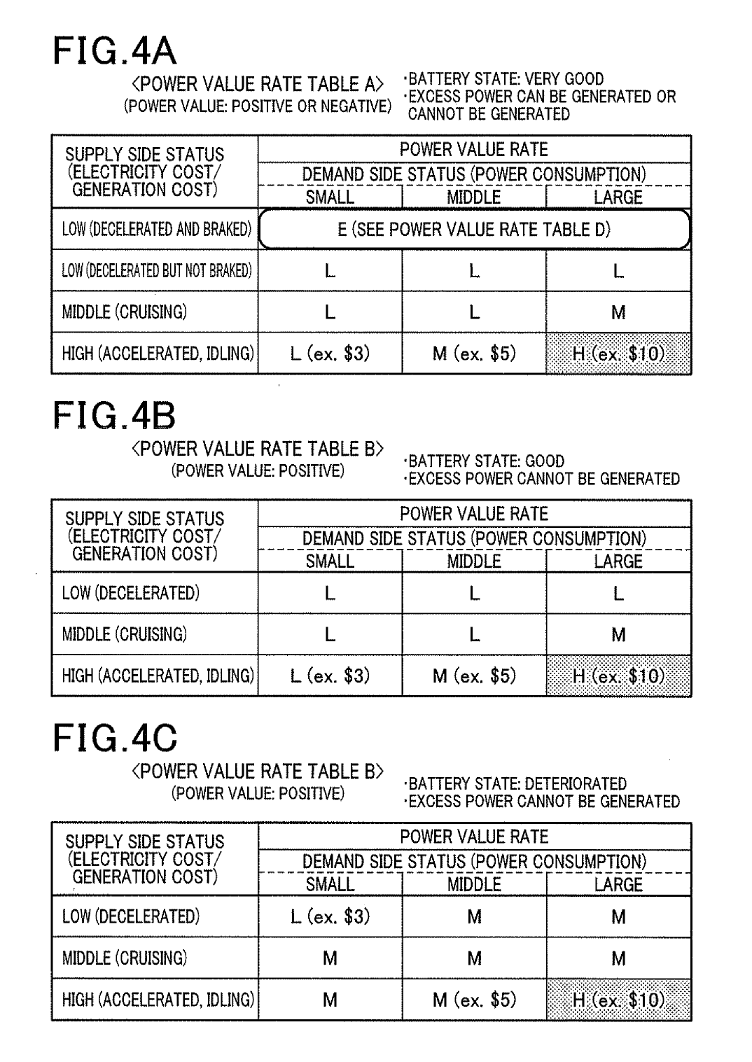

Specifically, the power manager 14 produces a power value according to a power value rate table (a kind of a map) stored in the memory 14b. Examples of the power value rate table are shown in FIGS. 4A to 4C. In the present embodiment, a suitable power value rate table is used depending on the state of the battery 12. That is, when the battery 12 is in a very good condition, the power manager 14 produces a power value according to a power value rate table A shown in FIG. 4A, when in a good condition, produces according to a power value rate table B shown in FIG. 4B, and when in a deteriorated condition, produces according to a power value rate table C shown in FIG. 4C. In any one of the conditions, a positive power value (corresponding to a indicating a second power value) is basically produced.

In the present embodiment, a positive power value is classified into three levels of H (High), M (Middle) and L (Low). Specifically, H is $10, M is $5 and L is $3. Depending on the electricity cost and power consumption, an appropriate power value is ensured to be set from among the three levels.

For example, the highest power value H is applied as shown in FIG. 4A when the battery 12 is in a very good condition, and the electricity cost (generation cost) transmitted from the power generation manager 17 is high and power consumption of the auxiliary machine system as a whole is large. On the other hand, the lowest power value L is applied as shown FIG. 4A when the battery 12 is in a very good condition, and the electricity cost is high but power consumption of the auxiliary machine system as a whole is small. However, when the electricity cost is high but power consumption is small, if the battery 12 is in a deteriorated condition, the power value is set to M as shown in FIG. 4C. Thus, when the electricity cost and power consumption remain unchanged but the battery 12 is in a deteriorated state, the power value is ensured to be set to a larger value as a rule than in the case where the battery 12 is in a very good condition.

As will be apparent from FIGS. 4A and 4B, set values of the positive power value are the same between the good condition and the very good condition of the battery 12. However, setting the same values in this way is only an example. Accordingly, for example, the power value may be set to a larger value, as a rule, in the case where the battery 12 is in a very good condition than in the case where the battery 12 is in a good condition. As a matter of course, the symbol “$” used as a unit of the power value is only an example and the values shown in the tables are also only examples.

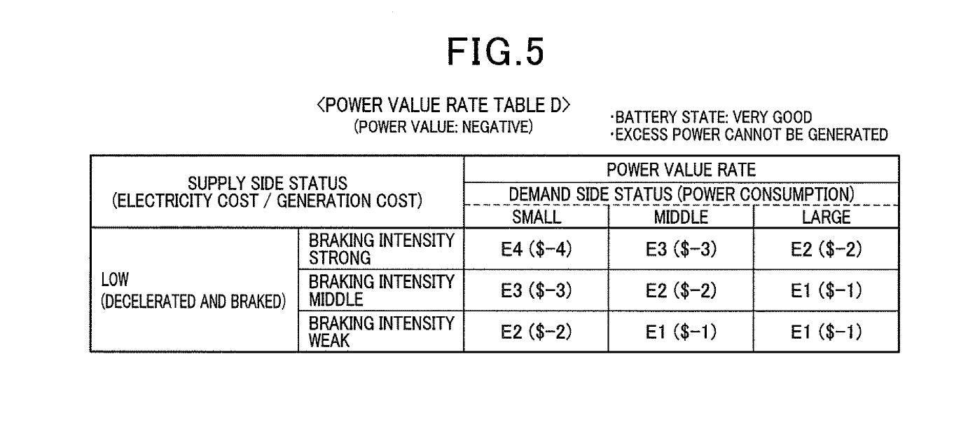

When the battery 12 is in a very good condition, the power value rate table A shown in FIG. 4A is basically used. In this case, when the vehicle is in the excess energy state as described above, a negative power value E (Excess) is applied as mentioned above. Specifically, the power value is produced according to a power value rate table D shown in FIG. 5.

As shown in FIG. 5, the negative power value (lowest value corresponding to a first power value) E applied in the excess energy state is determined according to the degree of the braking intensity.

Specifically, in the present embodiment, the degree of braking intensity is expressed by any one of three levels, i.e. strong, middle and weak. As a stronger braking intensity is applied, the vehicle is in a state where the kinetic energy of the vehicle in deceleration is desired to be more decreased. Accordingly, the vehicle is in a state where more power can be generated without consuming fuel. In other words, as a stronger braking intensity is applied, much more excess power can be generated and thus the electricity cost (generation cost) becomes much lower.

Accordingly, as shown in FIG. 5, when the vehicle is in the excess energy state, the power value is set according to the levels of the braking intensity, i.e., strong, middle and weak. In other words, the power value is set such that the power value becomes lower as a stronger braking intensity is applied. For example, when the vehicle is in the excess energy state and power consumption of the loads as a whole is of a middle degree, the power value is set to a value E1 ($−1) if the braking intensity is weak, but set to a smaller value E3 ($−3) if the braking intensity is strong. As has been the case with the power value rate table A, B or C shown in FIG. 4A, 4B or 4C, in the power value rate table D as well, the power value depends on the power consumption of the loads as a whole when the braking intensity remains unchanged (electricity cost remains unchanged).

In this way, the power manager 14 produces a power value according to the power value rate tables A to D shown in FIGS. 4A to 4C and FIG. 5, based on three statuses, i.e. statuses of the demand side, supply side and storage side. The power value is periodically produced so that a power value suitable for the latest vehicle condition can be constantly produced. Every time a power value is produced, the produced power value is transmitted to the individual loads via the communication line 10.

Each of the loads, on the other hand, determines whether or not the load should transit its mode to a power-saving mode, based on the power value transmitted from the power manager 14. If the mode of the load should be changed to a power-saving mode and the first user-set information is available, the mode is changed to the power-saving mode.

Specifically, a power purchasing ability is set in each of the loads in advance. More specifically, in the present embodiment, a power purchasing ability specific to each load is set with respect to both of positive and negative power values, in the determiner of the load.

The power purchasing ability corresponding to a positive power value is used as a reference in determining whether or not the power supplied from the alternator 11 and the battery 12 to each load can be unconditionally consumed (i.e., consumed in normal operating conditions without transiting into the power-saving mode), based on the value (power value) of the supplied power. In the present embodiment, the power purchasing ability corresponding to a positive power value is indicated by a numeral with the same unit as that of the power value.

The power purchasing ability is set to a larger value in those loads (e.g., the safety system loads 21 and the powertrain system loads 22) which should be preferentially activated. On the other hand, the power purchasing ability is set to comparatively a smaller value in those loads (e.g., the loads in the heating/air-conditioning system load group 30 and a part of the body system loads 23) which would hardly give adverse effect to the running of the vehicle if the operation is temporarily limited.

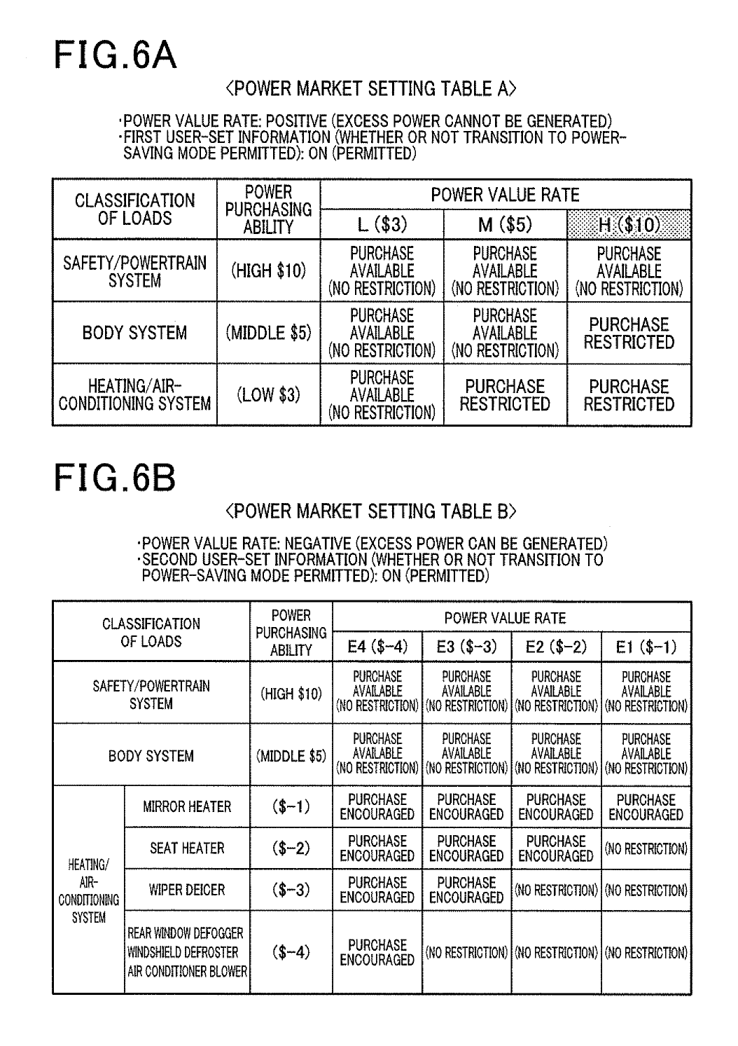

However, the power purchasing abilities are set based on the priority of the loads in the case where the first user-set information is available, i.e. in the case where transition to the power-saving mode has been permitted. Specifically, as shown in FIG. 6A, the power purchasing ability is set to be extra high (e.g., $10) in the safety system loads 21 and the powertrain system loads 22, a little lower (e.g., $3) in the loads of the heating/air-conditioning system load group 30, and approximately intermediate (e.g., $5) in the body system loads 23.

On the other hand, when the first user-set information is not available, i.e. when transition to the power-saving mode is not permitted, the power purchasing ability of all the loads is set to be extra high ($10), although not shown in the drawings.

Every time a power value is periodically transmitted, each load determines whether the power value is positive or negative. When positive, the load determines whether the power value is higher or lower than the power purchasing ability corresponding to the positive power value set in the load itself. If the power value is higher than the power purchasing ability, the load changes to the power-saving mode. If the power value is equal to or lower than the power purchasing ability, mode is changed to the normal operation mode. FIG. 6A shows a power market setting table A that indicates a relationship between power purchasing ability set in the loads and power value rate, when the power value is positive. For example, when a power value transmitted to the loads at some point is M ($5), the safety system loads 21, for example, which have the maximum power purchasing ability ($10) are applied with a behavior of “purchase available (no restriction)” as shown in the table, i.e. are capable of purchasing the power. The expression “capable of purchasing the power” refers to that the loads are able to unconditionally consume the power as it is supplied (i.e. able to perform the normal operation in conformity with the rating).

On the other hand, the loads of the heating/air-conditioning system load group 30, for example, having a low power purchasing ability are applied with a behavior of “purchase restricted” as shown in the table, i.e. are encouraged to change power consuming behavior. The “change of power consuming behavior” refers to transition to the power-saving mode in the present embodiment. However, this is only an example. There are a variety of specific processes of power consuming behavior, such as of completely cutting off power supply to a load to thereby stop the operation of the load.

As another example, when a load is applied with the behavior of “purchase restricted”, the load does not necessarily have to change the power consuming behavior (i.e. may continue to operate in the normal operation mode). Specifically, instead of being forcibly controlled by a command or the like of an external unit, such as the power manager 14, each load may independently determine, for example, whether its mode should be changed to the power-saving mode, or what specific action should be taken in the power-saving mode.

When the first user-set information is not available, transition to the power-saving mode is not permitted. In this case, the power purchasing ability of any of the loads is set to be extra high ($10). Accordingly, all of the loads are applied with the behavior of “purchase available (no restriction)”, irrespective of the transmitted power value.

FIG. 6B shows a power market setting table B used for the case where the transmitted power value is negative. As shown in FIG. 6B, in the loads 21, 22 and 23 excluding the loads of the heating/air-conditioning system load group 30, the power purchasing ability is set in a manner similar to the case where the power value is positive. Accordingly, the loads 21, 22 and 23 are applied with the behavior of “purchase available (no restriction)” irrespective of the specific value that the negative power value has. In other words, the loads 21, 22 and 23 are not restricted in the consumption of the supplied power but are able to unconditionally consume the power to carry out the normal operation.

On the other hand, when the power value is negative, the loads of the heating/air-conditioning system load group 30 are set with a negative power purchasing ability, unlike the power purchasing ability ($3) in the case of the positive power value. Moreover, a different value is set for each of the loads (specifically, on the basis of the rated power consumption of each load) as specifically shown in the power market setting table B of FIG. 6B. As shown, the mirror heater 33 is set with a highest ability of $−1, the seat heater 32 is set with a secondly highest ability of $−2, the wiper deicer 36 is set with a thirdly highest ability of $−3, and the rear window defogger 34, the windshield defroster 35 and the air conditioner blower 31 are set with the lowest ability of $−4.

Each of the loads of the heating/air-conditioning system load group 30 except for the cooling box 37 determines, every time a power value is periodically transmitted, as to whether the power value is positive or negative. When negative, each of the loads determines whether the power value is higher or lower than the power purchasing ability corresponding to the negative power value set in the load itself. If the power value is lower than the power purchasing ability of the load, the mode of the load is changed to the positive power-usage mode, and if equal to or higher than the power purchasing ability, changed to the normal operation.

The power market setting table B of FIG. 613 shows a relationship between power purchasing ability set in the loads and power value rate, in the case where the power value is negative. For example, when a power value transmitted in some point is E3 ($−3), the seat heater 32 having a power purchasing ability of $−2 higher than the power value is applied with a behavior of “purchase encouraged”, i.e. encouraged to increase output more than in the normal operation to consume more power. Specifically, the mode of the the seat heater 32 is changed to the positive power-usage mode. The load that has changed to the positive power-usage mode, if it has been operated at a “high” output level, increases its output to an “extra high” level, as described above.

When the power value has again been changed to positive, the mode is switched again from the positive power-usage mode to the normal operation mode. From this point, the load is operated for a predetermined set period with a low output which is lower than the output at the time of normal operation (the output immediately before transiting to the positive power-usage mode), as described above. Thus, power consumption is more reduced than in the normal operation.

In this way, power is increased and positively consumed to temporarily increase the power consumption of the load while the power value is negative, i.e. while the vehicle is in the excess energy state where excess power can be generated without consuming fuel. On the other hand, when the power value has again been changed to positive, the output of the load is decreased for a predetermined period to thereby realize power saving overall, allowing the load to exert the equivalent effects compared to the case where the normal operation would have been continued.

Taking the air conditioner blower 31 as an example, the excess power is used while the power value is negative to change the output level from “high” to “extra high” and carry out rapid cooling. After that, when the power value has again been changed to positive, the output level is lowered for a predetermined period. Overall, the time required for the temperature to reach a set temperature is approximately the same as the case where the normal operation would have been continued. In addition, since the output level is lowered for a predetermined period after the power value has again been changed to positive, fuel consumption required for power generation is decreased accordingly, contributing to power saving.

Specifically, when the vehicle is in the excess energy state, the kinetic energy of the vehicle, which could not have been recovered as regenerative energy in the conventional art, is positively used by the loads of the heating/air-conditioning system load group 30. As a result, power saving is realized. In other words, the idea is that, if there is power to be discarded, the power should rather be more positively consumed than in the normal operation to increase the effects exerted by the loads and that, later, the output level is lowered accordingly to resultantly realize power saving. When the second user-set information is not available, transition to the positive power-usage mode is not permitted. Accordingly, power purchasing ability is set to be lowest (e.g., $−5) in any one of the loads. Thus, all the loads are applied with the behavior of “purchase available (no restriction)”, irrespective of the value of the transmitted negative power value, and thus are operated in the normal operation mode. In the present embodiment, the mode of a load is changed to the positive power-usage mode throughout the period when the power value is negative. However, this is only an example. The mode of a load may be changed to the positive power-usage mode for a predetermined time after the power value has been changed to negative. Also, the time and degree of output reduction after the change of the power value from negative to positive can also be appropriately determined. As a result of the appropriate determination, the operation suitable for the type and function of each load may be realized so that, from the viewpoint such as of enjoying easy riding of the vehicle, uneasy factors are eliminated.

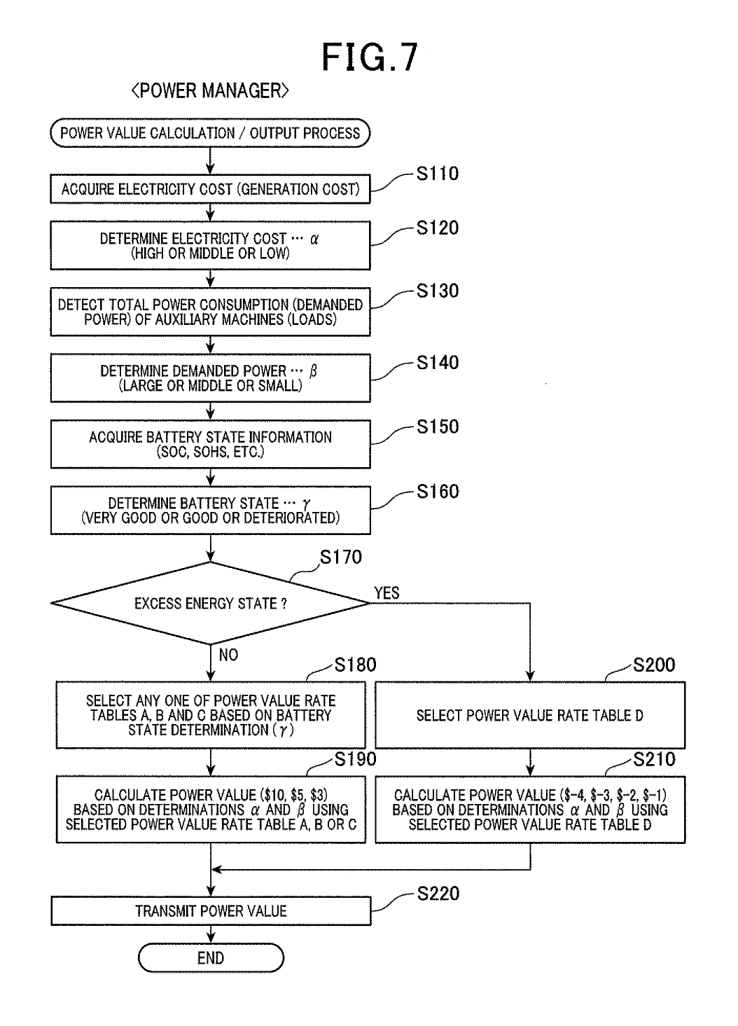

Referring now to FIG. 7, a power value calculation/output process is described. FIG. 7 is a flow diagram illustrating the power value calculation/output process performed by the power manager 14 (specifically performed by the microcomputer 14a). The microcomputer 14a periodically performs the process at a predetermined time interval. The microcomputer 14a, once the process is started, acquires, at step S110, an electricity cost (generation cost) transmitted from the power generation manager 17. Then, at step S120, the microcomputer 14a determines the level of the acquired electricity cost (generation cost) (determination α). In other words, the microcomputer 14a determines whether the electricity cost is high, low or middle from the viewpoint of the supply side status (see FIGS. 4A to 4C).

At the subsequent step S130, the microcomputer 14a detects a power consumption of the loads, i.e. a total power consumption (level of demand) of the auxiliary machine system as a whole. Specifically, the microcomputer 14a detects the total power consumption based on the results of the detection performed by the current sensor 13a. At step S140, the microcomputer 14a determines the level of demand based on the results of the detection (determination β). In other words, the microcomputer 14a determines whether the total power consumption is high, low or middle from the stance of the demand side status (see FIGS. 4A to 4C).

At the subsequent step S150, the microcomputer 14a acquires battery state information (e.g., SOC and SOH) transmitted from the power generation manager 17. At step S160, the microcomputer 14a determines whether the condition of the battery 12 is very good, good or deteriorated, based on the acquired battery state information (determination γ).

Then, at step S170, the microcomputer 14a determines whether the vehicle is in the excess energy state based on the results of the determination γ, and information regarding application or non-application of braking (including braking intensity) and information regarding the running state of the vehicle transmitted from the power generation manager 17. If the vehicle is not in the excess energy state, control proceeds to step S180. At step S180, the microcomputer 14a selects any one of the three power, value rate tables A, B and C shown in FIGS. 4A, 4B and 4C, respectively, based on the results of the determination (determination y) on the battery condition. Then, at step S190, the microcomputer 14a calculates a power value (positive power value here) using the selected power value rate table, on the basis of the results of the determinations α and β. Then, at step S220, the microcomputer 14a transmits the calculated positive power value to the loads via the communication line 10.

On the other hand, at step S170, the microcomputer 14a may determine that the vehicle is in the excess energy state when the battery 12 is in a very good condition and the vehicle is being decelerated with the application of braking. In this case, control proceeds to step S200 where the microcomputer 14a selects the power value rate table D shown in FIG. 5 because the vehicle is in the excess energy state. Then, at step S210, the microcomputer 14a calculates a power value (negative power value here) using the selected power value rate table D, based on the results of the determinations α and β. Then, at step S220, the microcomputer 14a transmits the calculated negative power value to the loads via the communication line 10.

Referring to FIG. 8, hereinafter is described an operation mode determination process. FIG. 8 is a flow diagram illustrating the operation mode determination process performed by the determiners 41, 42, 43, 44, 45 and 46 (or 41 to 46) of the loads 31, 32, 33, 34, 35 and 36 (or 31 to 36), respectively, except for the cooling box 37, composing the heating/air-conditioning system load group 30. The determiners 41 to 46 of the loads 31 to 36 periodically perform the process at a predetermined time interval. These loads 31 to 36 are ensured to operate in the normal operation mode in initial conditions immediately after start of the operation with the input of the power supply. Accordingly, flags are all in a cleared state.

Once the process is started, the loads 41 to 46 acquire, at step S310, a power value transmitted from the power manager 14 via the communication line 10. Then, at step S320, the loads 41 to 46 determine whether the acquired power value is positive or negative.

If the acquired power value is negative, i.e. if the vehicle is in the excess energy state, the determiners 41 to 46 clear, at step S410, the flag indicating transition to the power-saving mode and control proceeds to step S420. At step S420, the loads 41 to 46 acquire the second user-set information regarding whether the mode can be changed to the positive power-usage mode (i.e. whether the second user-set information is available or not available). Then, at step S430, the determiners 41 to 46 determine whether the respective loads themselves are operated at a “high” output level.

In this case, if the output level of the loads themselves is not “high” (e.g., if the output level is “middle” or “low”), control proceeds to step S470. At step S470, the determiners 41 to 46 clear the flag indicating transition to the positive power-usage mode to end the operation mode determination process. If the output level of the loads is “high”, control proceeds to step S440. At step S440, the determiners 41 to 46 each set a power purchasing ability based on the second user-set information acquired at step S420.

Specifically, as explained referring to the power market setting table B of FIG. 6B, when the second user-set information is available, the power purchasing ability is set to any one of $−1, $−2, $−3 and $−4 in each one of the loads 31 to 36. When the second user-set information is not available, the power purchasing ability is set to $−5 in all of the loads 31 to 36.

Then, at step S450, the determiners 41 to 46 each compare the set power purchasing ability with the power value (negative power value) acquired at step S310. If the power purchasing ability is equal to or higher than the power value, control proceeds to step S460 where the flag indicating transition to the positive power-usage mode is set up. Thus, the mode of the loads concerned is changed to the positive power-usage mode. Accordingly, as described above, the output level is turned to “extra high” throughout or in a part of the period when the power value is negative to positively consume power. Thus, the effects of the loads are increased more than in the normal operation. On the other hand, if the power purchasing ability is lower than the power value, control proceeds to step S470 where the determiners 41 to 46 clear the flag indicating transition to the positive power-usage mode. Thus, the loads concerned are operated in the normal operation mode.

If the acquired power value is positive in the determination process at step S320, the determiners 41 to 46 clear, at step S330, the flag indicating transition to the positive power-usage mode. At the subsequent step S340, the determiners 41 to 46 determine whether the determination on the power value at step S320 (whether the power value is positive or negative) was negative in the previous cycle of the operation mode determination process.

If the power value in the previous cycle determination was negative, control proceeds to step S480 where the determiners 41 to 46 start measuring time using a timer. Then, at the subsequent step S490, low output operation is started. Specifically, each of the loads is operated switching its operation level to “middle” or “low” at which smaller power is consumed than at the level (“high” here) immediately before the power value is changed to negative.

If the determiners 41 to 46 determine, at step S340, that the power value at step S320 in the previous cycle was not determined to be negative, control proceeds to step S350 where the determiners 41 to 46 determine whether the loads themselves are in low output operation. If the loads are in low output operation as they have been started accordingly at step S490, control proceeds to step S500 where the determiners 41 to 46 determine whether or not the time started to be measured at step S480 has elapsed a predetermined time. If the predetermined time has not yet elapsed, the determiners 41 to 46 immediately put an end to the operation mode determination process. If the predetermined time has elapsed, control proceeds to step S510 where the loads themselves are again permitted to be in the normal operation and then control proceeds to step S360. If the loads are determined, at step S350, not to be in low output operation as well, control to proceeds to step S360.

At step S360, the determiners 41 to 46 acquire the first user-set information regarding whether mode can be changed to the power-saving mode (i.e. whether the first user-set information is available or not available). Then, at step S370, the determiners 41 to 46 set a power purchasing ability based on the first user-set information acquired at step S360. In other words, as explained referring to the power market setting table A of FIG. 6A, if the first user-set information is available, the power purchasing ability is set to $3. If the first user-set information is not available, the power purchasing ability, is set to a high value (10$) in all of the loads.

Then, at step S380, the determiners 41 to 46 compare the set power purchasing ability with the power value acquired at step S310. If the power value is higher than the power purchasing ability, control proceeds to step S390 to set up a flag indicating transition to the power-saving mode. Thus, the mode of the loads concerned is changed to the power-saving mode. On the other hand, if the power value is equal to or lower than the power purchasing ability, control proceeds to step S400 where the determiners 41 to 46 clear the flag indicating transition to the power-saving mode. Thus, the loads concerned are operated in the normal operation mode.

As described above, the power management system 1 of the present embodiment sets a negative power value (first power value) when the vehicle is in the excess energy state. Thus, the loads 31 to 36, except for the cooling box 37, composing the heating/air-conditioning system load group 30 are encouraged to positively use power while the vehicle is in the excess energy state. When the power value is negative, the loads 31 to 36 are able to increase their output (increase power consumption) according to their operating conditions. However, when the power value has again been changed to positive after the increase of their output, their output is lowered for a predetermined period. Accordingly, overall, the effects of the loads are equivalent to the case where the loads would have been continuously operated in the normal operation mode but, moreover, power saving function of the vehicle is enhanced.

What is more, instead of positively controlling (predominating) the power supply and power delivery systems, the power manager 14 just periodically produces a power value (power information) for transmission to the loads. Thus, how power should actually be consumed is left to the loads.

Making use of current-value concept (market principles), the power manager 14 calculates an appropriate power value at the point based on both the demand and supply side statuses. Then, based on the calculated power value, the individual loads determine their behaviors.

This configuration can eliminate the configuration and control of the conventional art for selecting or connecting/disconnecting the paths for supplying and delivering power to the loads. Thus, the cost incurred in producing the system is reduced.

Further, instead of allowing the power manager 14 to positively control the loads for transition to the power-saving mode or the positive power-usage mode, the loads are ensured to independently determine transition to these modes. This configuration can eliminate the necessity of obtaining the broad information regarding the individual loads to realize the power manager 14. In other words, the role and configuration the power manager 14 is required to have are simple. Thus, the power manager 14 can be installed at low cost and with easy technique.

Furthermore, developers of the loads are ensured to have a degree of freedom in designing a power-saving configuration and can initiatively work on the development of the loads. Specifically, designers of the loads can maximally utilize their technical knowledge of the loads to be designed. Thus, an optimal design can be expected for each of the loads, which leads to highly viable power saving and enhancement of power saving function of each of the loads.

Specifically, kinetic energy of a vehicle can be more effectively used and thus power saving function of the vehicle can be more enhanced at low cost, with a simple configuration and with a method that can be easily introduced to a vehicle.

### Second Embodiment

In the first embodiment described above, the present invention has been applied to a conventional vehicle. However, the application of the present invention is not limited to conventional vehicles. For example, the present invention may be applied to hybrid vehicles that run using both an internal combustion engine and a motor as running power sources, or electric vehicles that run using only a motor without installing an internal combustion engine.

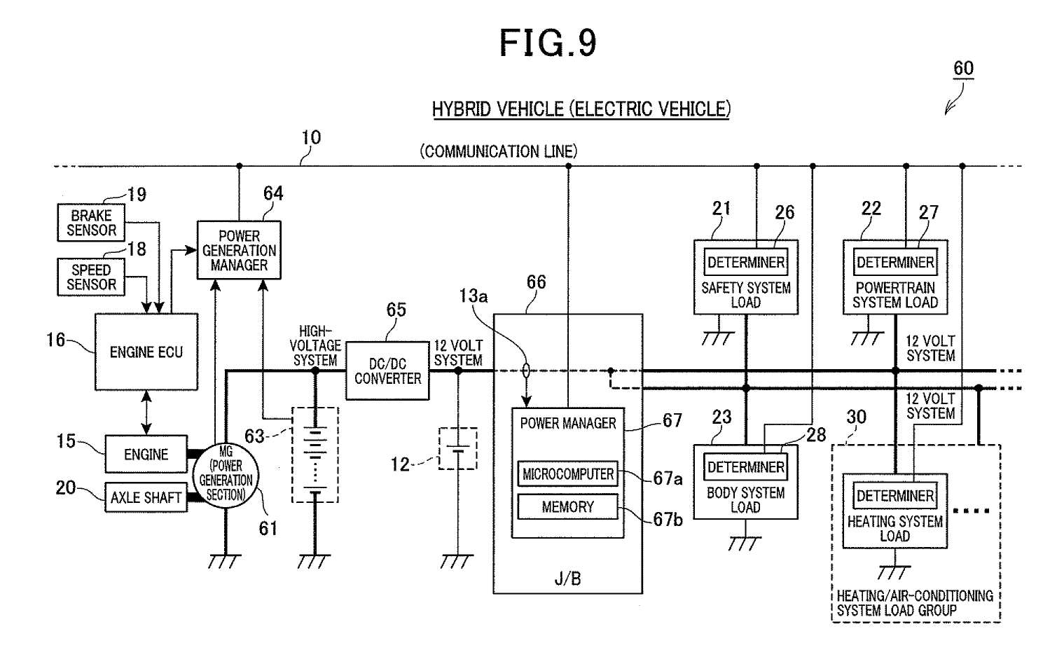

Referring to FIG. 9, hereinafter is described a second embodiment of the present invention, i.e. an application of the present invention to a hybrid vehicle or an electric vehicle. The second embodiment is described focusing on the differences from the power management system 1 (see FIG. 1) of the first embodiment. FIG. 9 is a schematic diagram illustrating a power management system 60 (corresponding to a vehicle power management system) according to the second embodiment. It should be appreciated that the power management system 60 shown in FIG. 9 is one applied to a hybrid vehicle, with reference to which the following description is provided. Further, in the second embodiment, the components identical with or similar to those in the first embodiment are given the same reference numerals for the sake of omitting unnecessary explanation.

The hybrid vehicle installing the power management system 60 of the present embodiment has an MG (motor-generator) 61 as a running power source in addition to the engine 15. The MG 61 is rotatable with power from a high-voltage battery 63. Thus, the vehicle is also able to run using only the MG 61.

The MG 61 also functions as a generator that generates electrical power with the drive force of the engine 15 or the torque of the axle shaft 20. Accordingly, for example, power is generated by the MG 61 when regenerative braking is applied in decelerating the vehicle and the generated power is charged into the high-voltage battery 63. Unlike the battery 12 of the first embodiment, the high-voltage battery 63 has a high voltage of about 300 V, for example.

The conventional vehicle in the first embodiment has only an engine as a power source. Thus, in the first embodiment, the fuel used by the power source corresponds to the drive energy of the present invention. In the second embodiment, on the other hand, the vehicle uses both the engine 15 and the MG 61 as power sources, Thus, both of the fuel and the stored power of the high-voltage battery 63 correspond to the drive energy of the present invention.

A power generation manager 64 has a basic function of controlling generation operation of the MG 61. Specifically, the power generation manager 64 has a basic function of controlling charge of the high-voltage battery 63 and supply of power to the loads (i.e. supply of power to a DC/DC converter 65) from the MG 61. Thus, the power generation manager 64 monitors various states, such as SOC and SHO, of the high-voltage battery 63. According to the various states of the high-voltage battery 63, the power generation manager 64 appropriately operates the MG 61 such as when the vehicle runs with the engine 15 or when regenerative braking is applied to the vehicle to thereby charge the high-voltage battery 63.

Further, the power generation manager 64 periodically calculates an electricity cost indicating the cost of power generated by the MG 61 and transmits the calculated electricity cost to a power manager 64 in a junction box (J/B) 66 via the communication line 10. In the present embodiment as well, the electricity cost is expressed by a fuel consumption (g/h/kW=g/kWh) per unit generated power.

The electricity cost becomes high at the time of acceleration or idling because fuel consumption of the MG 61 is increased for the generation of power. In contrast, at the time of deceleration, the braking energy of the vehicle is used for the MG 61 to generate power and thus fuel consumption for generation is approximated to zero to lower the electricity cost. The fuel consumption for generation during cruising is approximately intermediate between acceleration and deceleration and thus the electricity cost is also approximately intermediate.

In the case of electric vehicles, no fuel is consumed because they are not provided with the engine 15. Accordingly, unlike conventional vehicles or hybrid vehicles, there is no defining a fuel consumption per unit generated power as being an electricity cost. Therefore, in electric vehicles, a stored power of the high-voltage battery 63, instead of fuel, is regarded to be an energy source. For example, an amount of stored power change d·kWh/dt·Wh of the high-voltage battery 63 per unit time may be defined to be an electricity cost and used in processes. In electric vehicles as well, calculation of an electricity cost is performed by the power generation manager 64.

Hybrid vehicles and electric vehicles are similar in that the high-voltage battery 63 is a drive energy source. Accordingly, in hybrid vehicles as well, an electricity cost may be defined in a manner similar to electric vehicles, applying the calculation process similar to electric vehicles.

Hybrid vehicles or electric vehicles are not provided with an alternator. Therefore, in supplying power to the loads, the voltage of the high-voltage battery 63 is stepped down to 12 V by the DC/DC converter 65. The output voltage of the DC/DC converter 65 is stored in the battery 12. Accordingly, power is appropriately supplied to the loads from also the battery 12 (which is classified as an auxiliary battery).

A power manager (corresponding to a vehicle power information managing apparatus) 67 provided in the J/B 66 has a configuration basically similar to that of the power manager 14 of the first embodiment. Accordingly, the power manager 67 includes a microcomputer 67a, a memory 67b and the like. In this embodiment, the microcomputer 67a and the memory 67b are configured to function as an excess energy state judgment unit, a power value information generating unit, a sending unit, and a demanded power detector.

Thus, similar to the first embodiment, the power manager 67 performs the power value calculation/output process (see FIG. 7) based on: the information transmitted from the power generation manager 64 regarding the electricity cost (supply side status); application or non-application of braking (including braking intensity) and running condition of the vehicle also transmitted from the power manager 64; power consumption of the auxiliary machine system as a whole (demand side status) obtained based on the results of detection performed by the current sensor 13a; and the condition (very good, good or deteriorated) of the high-voltage battery 63 (storage side status). Thus, the power manager 67 produces a power value and transmits the power value to the individual loads.

Similar to the first embodiment, the memory 67b of the power manager 67 is stored with the power value rate tables A to D as shown in FIGS. 4A to 4C and FIG. 5. When the amount of stored power change of the high-voltage battery 63 is regarded as an electricity cost in hybrid vehicles and electric vehicles, the determination on the level of an electricity cost (high, middle or low) is appropriately made based on the amount of stored power change. Specifically, for example, when the stored power has been drastically decreased in a short time at the time of acceleration, for example, this means that the power of the high-voltage battery 63 has been consumed accordingly. Therefore, in this case, the electricity cost becomes high. On the other hand, when power is regeneratively generated during deceleration, the high-voltage battery 63 is in a state of being charged and thus stored power is gradually increased. Therefore, in this case, the electricity cost becomes low.

The configuration and operation of the loads are completely the same as those of the first embodiment. Accordingly, in the present embodiment as well, the loads 31 to 36, except for the cooling box 37, composing the heating/air-conditioning system load group 30 carry out the operation mode determination process as shown in FIG. 8.

### Modifications

The embodiments of the present invention have been described so far. However, the embodiments of the present invention are not limited to the ones set forth above. As a matter of course, the present invention may be implemented in various embodiments as far as the embodiments fall within the technical scope of the present invention.

In the embodiments described above, the vehicle has been determined to be in the excess energy state on condition that the battery is in a very good condition, and the vehicle is being decelerated with the application of braking. However, this is only an example.

In the above embodiments, the power value when the vehicle is in the excess energy state has been classified into three levels according to the intensity of braking intensity. However, this is also only an example. For example, the power value may be classified into two levels or four or more levels instead of three levels. For example, in determining a power value based on such a classification, other elements may be appropriately taken into account, such as the degree of deceleration of the vehicle or the inclination of the load on which the vehicle runs.

In other words, a power value may be determined according to the degree of potential generation of excess power. Accordingly, it may be so configured that, as the potential generation of excess power becomes higher, a lower power value is determined. In this way, the process of determining a power value may be configured as appropriate.

In the embodiments described above, while the loads are operated at a “high” output level, the loads of the heating/air-conditioning system load group 30 except for the cooling box 37 have been changed to the positive power-usage mode when the power value has been changed to negative. However, this is also only an example. For example, the loads of the load group 30 except for the cooling box 37 may be changed to the positive power-usage mode while the loads are operated at a “middle” output level, so that the loads are operated at a “high” or “extra high” output level. Alternatively, irrespective of the output level of the operation, the loads may be uniformly changed to the positive poser consumption mode to thereby increase the output level.

In the cooling box 37 as well, which is just simply turned on/off, the output may be increased by transiting the cooling box 37 into the positive power-usage mode when the power value is negative. Specifically, for example, when the power value has been changed to negative while the cooling box 37 is in an on-state and operated consuming a predetermined power, power consumption may further be increased from this operating condition. Also, when the power value has been changed to negative while the cooling box 37 is in an off-state, the cooling box 37 may be automatically turned on.

In the embodiments described above, the power manager has been provided in the J/B. However, this is only an example. The location of the power manager may be determined as appropriate. For example, the power manager may be incorporated into an engine ECU or a different ECU. Alternatively, the power manager may be provided in a dedicated ECU.

In the embodiments described above, the power value rate tables A to D (see FIGS. 4A to 4C and FIG. 5) have been stored in advance in the memory of the power manager to calculate a power value according to the power value rate tables A to D. However, this calculation process is only an example. The power value may be calculated using other various calculation processes.

In the embodiments described above, the loads are operated with the DC 12 V power from the battery 12. However, the present invention may be applied to those loads which are operated at a voltage other than 12 V. For example, when power is supplied to a load that operates at 42 V in a conventional vehicle, a step-up converter may be provided in the vehicle to step up the generated power (12 V) of the alternator to 42 V. When a load that operates at 42 V is provided in a hybrid vehicle or an electric vehicle, the voltage of the high-voltage battery 63 may be stepped up to 42 V by providing a converter, or the voltage stepped down to 12 V by the DC/DC converter 65 may again be stepped up to 42 V using a step-up converter. As a matter of course, the numerical value 42 V here is only an example.

The vehicles including a motor as a running power source, such as hybrid vehicles or electric vehicles, may include what is called a plug-in mechanism that can be connected to an external power source to charge the high-voltage battery 63 with the power from the external power source. The plug-in mechanism may be essential for electric vehicles, in particular, in which generation with an internal combustion engine is not available. The present invention can be applied to vehicles provided with the plug-in mechanism. In this application, when the high-voltage battery is connected to an external power source and charged with the externally supplied power, the charging capacity of the high-voltage battery is increased. Accordingly, since the charging capacity of the high-voltage battery is increased when externally charged, the electricity cost may be set to be very low to activate more number of electrical loads with no worry about the consumption of the stored power.

On or after the charging capacity of the high-voltage battery has reached a target capacity while being charged being connected to an external power source, the vehicle is in the excess energy state as far as power is supplied from the external power source. Accordingly, in such a case, a negative power value may be set as in the above embodiments.

In the embodiments described above, the term “value of a power (power value)” is used. In this usage, the meaning of the term “value” includes “cost”, “price” or the like. For example, the term “value of a power (power value)” may be expressed as the term “cost of a power (power cost)” or “price of a power (power price)”.

What is claimed is:

1. A vehicle power management system mounted in a vehicle, the vehicle comprising:
a plurality of electrical loads;
a battery that supplies electric power to the electrical loads for driving the electrical loads; and
a power generator that can generate electric power from torque of a wheel of the vehicle during running of the vehicle and, from the generated electric power, supplies a required electric power to the electrical loads while charging the battery to a predetermined target capacity,
the power management system managing the electric power supplied to the electrical loads and comprising:
an excess energy state judgment unit that judges whether or not the vehicle is in an excess energy state which is capable of generating an excess power in addition to a required generated power without consuming drive energy for a running of the vehicle, the required generated power being an electric power needed to be currently generated, the excess power being an excess available power exceeding the required generated power; and
a power value information generating unit that generates power value information indicating a power value which is derived on the basis of a balance between a power supply and a power demand for the electric power supplied from at least one of the power generator and the battery to the electrical loads, and that also generates, as the power value information, first power value information if judged that the vehicle is in the excess energy state, the first power value information indicating a first power value which is the power value when the vehicle is in the excess energy state, the first power value being set to be lower than a second power value which is the power value when the vehicle is not in the excess energy,
at least one of the electrical loads being configured to be responsive to an increase in the electric power and including a power consumption increasing unit that, when the first power value information is generated by the power value information generating unit during operation of the load, increases a power consumption of the load during a part or all of a period where the the first power value information is generated so as to be larger than a power consumption of the load immediately before the first power value information is generated.

2. The vehicle power management system according to claim 1, wherein:
the power consumption of the load is increased by the power consumption increasing unit when generation of the first power value information is started during operation of the load, and is subsequently decreased during a predetermined period so as to be lower than a power consumption before the generation of the first power value information, when the generation of the first power value information is completed.

3. The vehicle power management system according to claim 2, wherein:
power-increase-ability information is set in advance in the load, the power-increase-ability information being a reference in judging whether or not the power consumption increasing unit can increase the power consumption on the basis of the value indicated by the first power value information; and
the vehicle power management system further comprises:
a power-increase judgment unit that judges whether or not the power consumption increasing unit can increase the power consumption by comparing the power-increase-ability information with the first power value information, and that increases the power consumption if judged that the power consumption increasing unit can increase the power consumption.

4. The vehicle power management system according to claim 3, further comprising:
a demanded power detector that detects a demanded power which is an electric power actually consumed by the plurality of the electrical loads,
wherein the power value information generating unit generates the first power value information such that the lower the demanded power the lower the first power value.

5. The vehicle power management system according to claim 4, wherein:
if judged that the vehicle is in the excess energy state, the excess energy state judgment unit performs an excess power judgment which is a judgment of how much excess power can be generated without consuming the drive energy for the running of the vehicle; and
the power value information generating unit generates the first power value information such that the larger the excess power the lower the first power value on the basis of the amount of the excess power which is judged by the excess power judgment performed by the excess energy state judgment unit.

6. The vehicle power management system according to claim 5, wherein.:
the excess energy state judgment unit judges that the vehicle is in the excess energy state, when (i) the battery is charged to the target capacity, and (ii) a braking of the vehicle is applied, during running of the vehicle.

7. The vehicle power management system according to claim 1, wherein:
power-increase-ability information is set in advance in the load, the power-increase-ability information being a reference in judging whether or not the power consumption increasing unit can increase the power consumption on the basis of the value indicated by the first power value information; and
the vehicle power management system further comprises:
a power-increase judgment unit that judges whether or not the power consumption increasing unit can increase the power consumption by comparing the power-increase-ability information with the first power value information, and that increases the power consumption if judged that the power consumption increasing unit can increase the power consumption.

8. The vehicle power management system according to claim 1, further comprising:
a demanded power detector that detects a demanded power which is an electric power actually consumed by the plurality of the electrical loads,
wherein the power value information generating unit generates the first power value information such that the lower the demanded power the lower the first power value.

9. The vehicle power management system according to claim 1, wherein:
if judged that the vehicle is in the excess energy state, the excess energy state judgment unit performs an excess power judgment which is a judgment of how much excess power can be generated without consuming the drive energy for the running of the vehicle; and
the power value information generating unit generates the first power value information such that the larger the excess power the lower the first power value on the basis of the amount of the excess power which is judged by the excess power judgment performed by the excess energy state judgment unit.

10. The vehicle power management system according to claim 1, wherein:
the excess energy state judgment unit judges that the vehicle is in the excess energy state, when (i) the battery is charged to the target capacity, and (ii) a braking of the vehicle is applied, during running of the vehicle.

11. A vehicle power information managing apparatus mounted in a vehicle, the vehicle comprising:
a plurality of electrical loads;
a battery that supplies electric power to the electrical loads for driving the electrical loads; and
a power generator that can generate electric power from torque of a wheel of the vehicle during running of the vehicle and, from the generated electric power, supplies a required electric power to the electrical loads while charging the battery to a predetermined target capacity,
the power information managing apparatus managing the electric power supplied to the electrical loads and comprising:
an excess energy state judgment unit that judges whether or not the vehicle is in an excess energy state which is capable of generating an excess power in addition to a required generated power without consuming drive energy for a running of the vehicle, the required generated power being an electric power needed to be currently generated, the excess power being an excess available power exceeding the required generated power;
a power value information generating unit that generates power value information indicating a power value which is derived on the basis of a balance between a power supply and a power demand for the electric power supplied from at least one of the power generator and the battery to the electrical loads, and that also generates, as the power value information, first power value information if judged that the vehicle is in the excess energy state, the lowest-value information indicating a first power value which is the power value when the vehicle is in the excess energy state, the first power value being set to be lower than a second power value which is the power value when the vehicle is not in the excess energy; and
a sending unit that sends the first power value information generated by the power value information generating unit to at least one of the electrical loads which is configured to be responsive to an increase in the electric power.

12. The vehicle power information managing apparatus according to claim 11, further comprising:
a demanded power detector that detects a demanded power which is an electric power actually consumed by the plurality of the electrical loads,
wherein the power value information generating unit generates the first power value information such that the lower the demanded power the lower the first power value.

13. The vehicle power information managing apparatus according to claim 12, wherein:
if judged that the vehicle is in the excess energy state, the excess energy state judgment unit performs an excess power judgment which is a judgment of how much excess power can be generated without consuming the drive energy for the running of the vehicle; and
the power value information generating unit generates the first power value, information such that the larger the excess power the lower the first power value on the basis of the amount of the excess power which is judged by the excess power judgment performed by the excess energy state judgment unit.

14. The vehicle power information managing apparatus according to claim 13, wherein:
the excess energy state judgment unit judges that the vehicle is in the excess energy state, when (i) the battery is charged to the target capacity, and (ii) a braking of the vehicle is applied, during running of the vehicle.

15. The vehicle power information managing apparatus according to claim 11, wherein:
if judged that the vehicle is in the excess energy state, the excess energy state judgment unit performs an excess power judgment which is a judgment of how much excess power can be generated without consuming the drive energy for the running of the vehicle; and
the power value information generating unit generates the first power value information such that the larger the excess power the lower the first power value on the basis of the amount of the excess power which is judged by the excess power judgment performed by the excess energy state judgment unit.

16. The vehicle power information managing apparatus according to claim 11, wherein:
the excess energy state judgment unit judges that the vehicle is in the excess energy state, when (i) the battery is charged to the target capacity, and (ii) a braking of the vehicle is applied, during running of the vehicle.

17. A vehicle electrical load mounted in a vehicle,
the vehicle comprising:
a battery; and
a power generator that can generate electric power from torque of a wheel of the vehicle during running of the vehicle and, from the generated electric power, supplies a required electric power to a predetermined supplied object while charging the battery to a predetermined target capacity,
the electrical load being activated by electric power supplied from the battery or the power generator, and being configured to:
(a) receive power value information indicating a power value which is derived on the basis of a balance between a power supply and a power demand for the supplied electric power; and
(b) receive first power value information as the power value information, when the vehicle is in an excess energy state which is capable of generating an excess power in addition to a required generated power without consuming drive energy for a running of the vehicle, the required generated power being an electric power needed to be currently generated, the excess power being an excess available power exceeding the required generated power, the first power value information indicating a first power value which is the power value when the vehicle is in the excess energy state, the first power value being set to be lower than a second power value which is the power value when the vehicle is not in the excess energy,
the electrical load comprising:
a power consumption increasing unit that, when the first power value information is received during operation of the load, increases a power consumption of the load during a part or all of a period where the the first power value information is received so as to be larger than a power consumption of the load immediately before the first power value information is received.

18. The vehicle electrical load according to claim 17, wherein:
the power consumption of the load is increased by the power consumption increasing unit when generation of the first power value information is started during operation of the load, and is subsequently decreased during a predetermined period so as to be lower than a power consumption before the generation of the first power value information, when the generation of the first power value information is completed.

19. The vehicle electrical load according to claim 18, wherein:
power-increase-ability information is set in advance in the load, the power-increase-ability information being a reference in judging whether or not the power consumption increasing unit can increase the power consumption on the basis of the value indicated by the first power value information; and
the vehicle power management system further comprises:
a power-increase judgment unit that judges whether or not the power consumption increasing unit can increase the power consumption by comparing the power-increase-ability information with the first power value information, and that increases the power consumption if judged that the power consumption increasing unit can increase the power consumption.

20. The vehicle electrical load according to claim 17, wherein:
power-increase-ability information is set in advance in the load, the power-increase-ability information being a reference in judging whether or not the power consumption increasing unit can increase the power consumption on the basis of the value indicated by the first power value information; and
the vehicle power management system further comprises:
a power-increase judgment unit that judges whether or not the power consumption increasing unit can increase the power consumption by comparing the power-increase-ability information with the first power value information, and that increases the power consumption if judged that the power consumption increasing unit can increase the power consumption.
